(19) United States
(12) Patent Application Publication
(10) Pub. No.: US 2010/0320400 A1
(43) Pub. Date: Dec. 23, 2010

(54) EXPOSURE DEVICE

(75) Inventors: Yong Hyun Jin, Seoul (KR); Young Tae Kim, Gyeonggi-do (KR); Gun Jung Yoon, Seoul (KR); Ji Sook Kim, Seoul (KR); Gi Woo Lee, Gyeonggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/543,933

(22) Filed: Aug. 19, 2009

(30) Foreign Application Priority Data
Jun. 19, 2009 (KR) 10-2009-0055070

(51) Int. Cl. B01J 19/12

(52) U.S. Cl. 250/492.1

(57) ABSTRACT

The present invention relates to an exposure device. There is provided an exposure device including: a case; a plurality of LEDs that are received inside the case and emit light in an UV wavelength range straightly to the outside; and a power supplier that supplies power applied to the LEDs.

### CROSS REFERENCE RELATED APPLICATIONS

The present application claims priority under 35 U.S.C. 119 and 35 U.S.C. 365 to Korean Patent Application No. 10-2009-0055070 (filed on Jun. 19, 2009), which is hereby incorporated by reference in its entirety.

### BACKGROUND OF THE INVENTION

1. Field of the Invention

The present invention relates to an exposure device, and more particularly, to an exposure device that is received inside a case and has a plurality of LEDs that emit light in a UV wavelength range straightly to the outside.

2. Description of the related art

Generally, lithography collectively refers to a method and a process to draw a semiconductor integrated circuit on a surface of a semiconductor. As the sort of lithography, there are photolithography, electron beam lithography, and X-ray lithography.

Herein, the photolithography process is a process to selectively emit light to photoresist using a mask in a desired pattern by using a principle that the photoresist having photosensitive property causes a chemical reaction if it receives light to change its property, thereby forming the same pattern as the mask pattern.

The photolithography process includes a photoresist (PR) coating process that coats photoresist on an object, that is, on a substrate or a semiconductor wafer, an exposure process that selectively emits light using a desired mask pattern, and a developing process that removes photoresist on a portion where light is received using developer to form a pattern. And, a device to perform such a photolithography process is referred to as an exposure device. At this time, a UV lamp is mainly used as a light source of the exposure device.

With the exposure device using the UV lamp as described above, a thermal deformation of the mask pattern is commonly generated due to severe heat of the lamp. Therefore, a problem arises in that reliability and durability of a product are degraded.

Further, with the exposure device using the UV lamp as described above, there is a predetermined distance between the object and the UV lamp due to the heat of the lamp, commonly causing diffraction of light of the UV lamp.

Therefore, a fresnel lens is further provided on an upper part of the exposure device for uniform UV irradiation. However, the fresnel lens is an expensive product that determines the price of the exposure device by ½ or more, having a disadvantage that it increases a burden in manufacturing the exposure device and maintaining and fixing thereof.

### SUMMARY OF THE INVENTION

The present invention proposes to solve the disadvantages and problems presented in an exposure device. It is an object of the present invention to provide an exposure device that includes a case and a plurality of LEDs that are received inside the case and emit light in an UV wavelength range straightly to the outside, thereby making it possible to minimize heating value.

In order to accomplish the object, according to an embodiment of the present invention, there is provided an exposure device including: a case; a plurality of LEDs that are received inside the case and emit light in an UV wavelength range straightly to the outside; and a power supplier that applies power to the LEDs.

At this time, an irradiation angle of the LED may be in 5° to 45°, an opened angle of an opening portion of a molding part may be in 90° to 140°, a depth of the opening portion may be in 2 to 7 mm, a thickness of a LED chip mounted in the opening portion may be in 1 to 4 mm, and an angle of a lens coupled to an upper surface of the molding part may be in 45° to 90°.

Further, the exposure device may further include an operating member that is disposed in the outside of the case to be electrically connected to the power supplier to control the power supplier.

Moreover, the operating member may include an operator that turns on/off the exposure and a controller that controls the LEDs.

In addition, the controller may include a light quantity adjusting unit that adjusts the light quantity of the LEDs.

Also, the plurality of LEDs may be grouped for each group, and the controller may include a driver that selectively drives the LEDs for each group.

Further, the case may be formed of plastic or stainless.

Moreover, the exposure device may further include an upper surface cover that is disposed on the upper surface of the case and is formed of transparent material.

The exposure device may further include a protecting member that is disposed on the upper part of the case.

### BRIEF DESCRIPTION OF THE DRAWINGS

FIG. 1 is a cross-sectional view of an exposure device according to an embodiment of the present invention;

FIG. 2 is a cross-sectional view of a LED package adopted to an embodiment of the present invention;

FIG. 3a is a constitutional diagram of an operating member adopted to an embodiment of the present invention, and FIG. 3b is a plan view showing a light-emitting range for each LED region adopted to an embodiment of the present invention.

### DESCRIPTION FOR KEY ELEMENTS IN THE DRAWINGS

| | |
|---|---|
| 100: Exposure device | 110: Case |
| 120: LED | 130: Power supplier |
| 140: Operating member | |

### DETAILED DESCRIPTION OF THE PREFERRED EMBODIMENTS

The acting effects as well as the technical constitution of an exposure device according to the present invention will be clearly understood by the detailed description below with reference to the accompanying drawings where the exemplary embodiments of the present invention are illustrated.

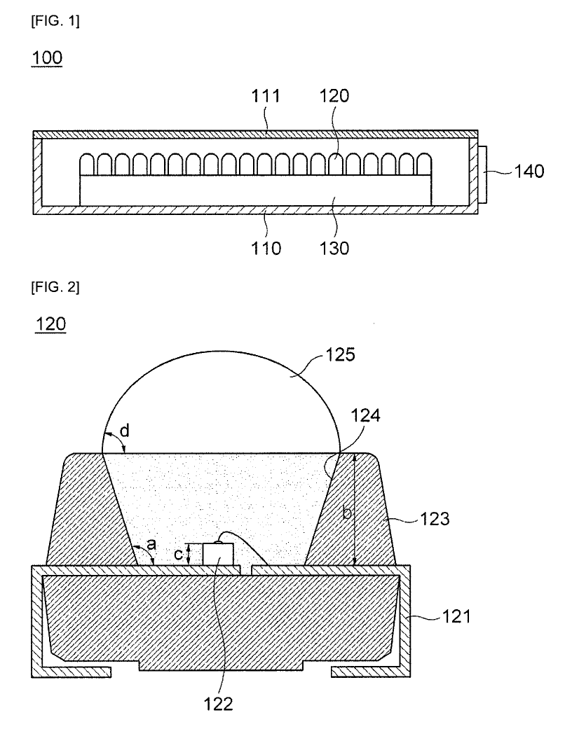

Hereinafter, an exposure device according to an embodiment of the present invention will be described in detail with reference to FIGS. 1 to 3.

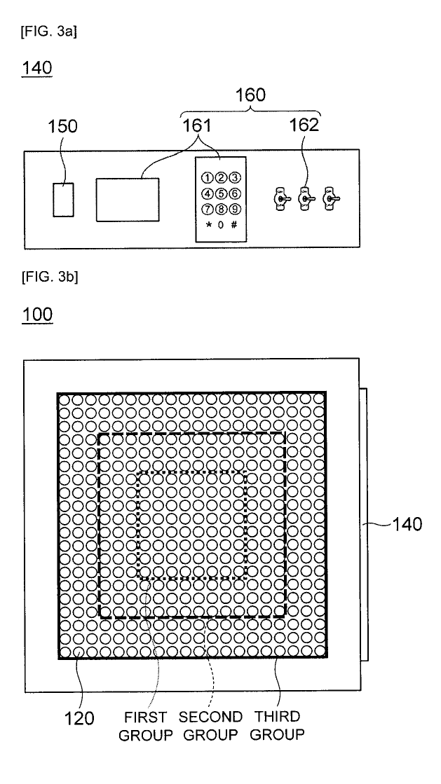

FIG. 1 is a cross-sectional view of an exposure device according to an embodiment of the present invention, FIG. 2 is a cross-sectional view of a LED package adopted to an embodiment of the present invention, FIG. 3a is a constitutional diagram of an operating member adopted to an embodiment of the present invention, and FIG. 3b is a plan view showing a light-emitting range for each LED region adopted to an embodiment of the present invention.

Referring to FIGS. 1 to 3, the exposure device 100 according to the embodiment of the present invention includes a case 110, LEDs 120 received inside the case 110, and a power supplier 130 that supplies power to the LEDs 120.

Herein, the exposure device 100 is an equipment that emits light to a photomask in a manufacturing line necessary for a circuit process such as a semiconductor, a TFT LCD, etc., to draw a circuit on an object, that is, a semiconductor wafer or a TFT LCD substrate.

The case 110 is manufactured in a rectangular parallelepiped shape to have a predetermined space that receives the plurality of LEDs 120 therein.

The case 110 may be formed of plastic or stainless that has a high reflection efficiency against the light in a UV wavelength range emitted from the LEDs 120 and a strong durability.

Further, an upper surface cover 111 may be provided on the upper surface of the case. The upper surface cover may be formed of transparent member through which the light in the UV wavelength range emitted from the LEDs 120 can pass. At this time, the sort of the transparent member may be formed of transparent glass or plastic, etc.

The LEDs 120 emit light in the UV wavelength range to the outside. At this time, the LEDs 120 are configured of UV LEDs having a wavelength range below 400 mm, that is, an ultraviolet ray region. The UV LEDs 120 are advantageous in that clear brightness can be implemented with a low heating value.

An irradiation angle of the LEDs 120 is in 5° to 45° based on the vertical direction to emit light straightly to the outside.

As shown in FIG. 2, such a LED 120 includes a lead frame 121, a LED chip 122 that is attached to one surface of lead frame 121 to be electrically connected to the lead frame 121, a molding part 123 that receives a portion of the lead frame 121 therein and has an opening portion 124, and a lens 125 that is coupled to the upper surface of the molding part 123.

At this time, the irradiation angle of the LED 120 may be controlled by changing an opened angle a of the opening portion 124 of the molding part 123, a depth b of the opening portion 124, a thickness c of the LED chip 122, and an angle d of the lens 125.

In order that the LED 120 has the irradiation angle as described above, preferably, the opened angle a of the opening portion 124 of the molding part 123 is in 90° to 140°, the depth b of the opening portion 124 is in 2 to 7 mm, the thickness c of the LED chip 122 mounted in the opening portion 124 is in 1 to 4 mm, and the angle d of the lens 125 coupled to the upper surface of the molding part 123 is in 45° to 90°.

As described above, since the plurality of LEDs 120 that straightly emit the light in the UV wavelength range as a light source of the exposure device 100 are provided, diffraction of the light is minimized, making it possible to improve yield and quality of a product. Moreover, since there is no need to separately include a fresnel lens provided in an exposure device in the related art, making it possible to reduce a burden in manufacturing the exposure device 100, and maintaining and fixing thereof.

The LEDs 120 are received inside the case 110, wherein the LEDs 120 are arranged in a plurality of rows and columns at a predetermined pitch length.

The plurality of LEDs 120 may be grouped for each predetermined region according to positions disposed in the case 110. For example, the plurality of LEDs 120 may be divided into groups from a first group to a third group, as shown in FIG. 3b. The first group is a region configured of a plurality of LEDs 120 disposed in a central position, and the second and third groups are regions that are gradually widen from the first group, that is, regions configured of a plurality of LEDs disposed in the outside. The grouping of the LEDs 120 is not limited thereto, but it may be easily changed, as needed.

As shown in FIG. 3a, an operating member 140 may further be provided on one side of the case 110 or in the outside. The operating member 140 is electrically connected to the power supplier 130 to control the power supplier 130. At this time, the operating member 140 may include an operator 150 and a controller 160.

The operator 150 receives power from the outside to turn on/off the exposure device 100. At this time, the operator 150 may be formed in a switch form or in a button form.

The controller 160 controls the LED 120, wherein the controller 160 may include a light quantity adjusting unit 161 and a driver 162.

The light quantity adjusting unit 161 can adjust the light quantity of the LEDs 120. At this time, the light quantity adjusting unit 161 may include a touch panel into which a user can directly input his or her desired light quantity values and a display panel on which the input values are displayed.

The driver 161 can selectively drive the emission of the plurality of LEDs 120 grouped for each region.

The driver 161 may be constituted in the form of a plurality of switches or buttons, each connected to the grouped plurality of LEDs 120. At this time, the detailed description on the driving of the plurality of LEDs 120 disposed for each region according to the operation of the driver 161 will be described later in detail.

A protecting member (not shown) may further provided on the upper surface of the case 110.

The protecting member may be formed of rubber or cloth, etc. in order to prevent the upper surface cover 111 of the case from being scratched or damaged.

The power supplier 130 is provided on the lower part of the LED 120 to apply power to the LEDs 120. The power supplying condition of the power supplier 130 may vary according to the operation of the operating member 140.

When the operator 160 of the operating member 140 is turned on, the power supplier 130 applies power to the LEDs 120 to light-emit the LEDs 120.

At this time, the power supplier 130 includes a circuit wiring for providing the power transferred from the operator 160 to the LEDs 120. The circuit wiring may be electrically connected to the plurality of LEDs 120 for each individual or for each group. This will be described later in detail.

The power supplier 130 applies current value corresponding to light quantity values input from the light quantity adjusting unit 161 of the operating member 140 to the LED 120, thereby light-emitting the LED 120.

Further, the power supplier 130 can apply power only to the plurality of LEDs 120 in the group selected from the driver 162 of the operating member 140. For example, if the input values corresponding to the first group of the LEDs 120 are input to the power supplier 130 from the driver 162, the power supplier 130 applies power only to the plurality of LEDs 120 disposed in the first group.

As described above, the exposure device 100 can easily adjust the light emitting regions of the LEDs 120 according to the exposure area of the object. Therefore, the exposure device 100 prevents unnecessary LEDs 120 from being supplied with power, making it possible to reduce work costs.

As described above, the exposure device according to the present invention is provided with the plurality of LEDs that are received inside the case to emit the light in the UV wavelength range straightly to the outside, such that diffraction of the light and the heating value are minimized, making it possible to improve the yield and quality of a product.

Moreover, the LEDs that emit light straightly are provided as the light source of the exposure device, such that there is no need to separately use a fresnel lens, making it possible to reduce a burden in manufacturing the exposure device, and maintaining and fixing thereof.

In addition, the exposure device includes the driver, such that the light emitting regions of the LEDs can be easily adjusted according to the exposure area of the object, thereby having advantages in view of work costs and work efficiency.

Although the preferred embodiment of the present invention is described, it will be apparent to those skilled in the art that various modifications and variations can be made in the present invention without departing from the spirit or scope of the inventions.

Therefore, it is intended that the present invention covers the modifications and variations of this invention provided they come within the scope of the appended claims and their equivalents.

What is claimed is:

1. An exposure device, comprising:
a case;
a plurality of LEDs that are received inside the case and emit light in an UV wavelength range straightly to the outside; and
a power supplier that applies power to the LEDs.

2. The exposure device according to claim 1, wherein an irradiation angle of the LED is in 5° to 45°.

3. The exposure device according to claim 2, wherein an opened angle of an opening portion of a molding part is in 90° to 140°, a depth of the opening portion is in 2 to 7 mm, a thickness of a LED chip mounted in the opening portion is in 1 to 4 mm, and an angle of a lens coupled to an upper surface of the molding part is in 45° to 90°.

4. The exposure device according to claim 1, further comprising:
an operating member that is disposed in the outside of the case to be electrically connected to the power supplier to control the power supplier.

5. The exposure device according to claim 4, wherein the operating member includes an operator that turns on/off the exposure.

6. The exposure device according to claim 4, wherein the operating member includes a controller that controls the LEDs.

7. The exposure device according to claim 6, wherein the controller includes a light quantity adjusting unit that adjusts the light quantity of the LEDs.

8. The exposure device according to claim 6, wherein the plurality of LEDs are grouped for each group, and the controller includes a driver that selectively drives the LEDs for each group.

9. The exposure device according to claim 1, wherein the case is formed of plastic or stainless.

10. The exposure device according to claim 1, further comprising:
an upper surface cover that is disposed on the upper surface of the case and is formed of transparent material.

11. The exposure device according to claim 1, further comprising:
a protecting member that is disposed on the upper part of the case.
